(19) United States
(12) Patent Application Publication
(10) Pub. No.: US 2016/0311616 A1
(43) Pub. Date: Oct. 27, 2016

(54) WHEEL SUSPENSION FOR SHUTTLE

(71) Applicant: TEXO APPLICATION AB, Älmhult (SE)

(72) Inventor: Bo LINDBLOM, Osby (SE)

(21) Appl. No.: 15/103,335

(22) PCT Filed: Nov. 28, 2014
(86) PCT No.: PCT/SE2014/051422

§ 371 Date: Jun. 10, 2016

(30) Foreign Application Priority Data
Dec. 10, 2013 (SE) 1351474-0

(51) Int. Cl. B65G 1/04

(52) U.S. Cl. CPC B65G 1/0492; B65G 1/0414

(57) ABSTRACT

Wheel suspension for a basically rectangular shuttle moveable on two parallel elongated rails arranged in a horizontal plane, wherein the wheel suspension includes shuttle wheels arranged in corners of the shuttle. At least two shuttle wheels separated in the direction of movement of the shuttle, and rotatable in a vertical plane, are carried by a bogie arranged in each corner of the shuttle. The bogie is pivotally arranged on a first axis, in a side section of the shuttle, wherein the first axis is arranged between the two shuttle wheels carried by a bogie, and is on an underside formed with a cam surface at least partially extending below the shuttle wheels, wherein the bogie is pivoted upwardly when the cam surface engages a stationary arranged cam roll. A crane, movable between several sets of two elongated rails, and carrying supporting corresponding rails, for transporting the shuttle, wherein the cam roll is stationary attached to the crane.

### FIELD OF INVENTION

The invention refers to a wheel suspension for a shuttle moveable on two elongated parallel rails arranged in a horizontal plane, and a transport device for the shuttle.

### STATE OF THE ART

Storage systems, for example pallet racking systems, for high-bay storages and similar types of storages, comprises a high number of beams and rails on which goods, preferably in the form of pallets, can be stored. Usually, there are arranged a plurality of storeys, and elevators and/or cranes can be used to transport goods vertically and laterally. There also exist carriages and cranes that move in aisles between pair of rails. Automated storage systems comprise shuttles, which autonomously move on a pair of rails and can fetch and leave goods on the rails. The shuttles roll on a plurality of wheels and can be transported on cranes, elevators or carriages on which rails are arranged, having the same dimensions as those of the pallet racks.

The shuttles are controlled by control systems and a plurality of sensors sense the positions and movements of the shuttles. There is always arranged an interspace between rails on the pallet racks, and the rails of the cranes, the elevators, and carriages. The shuttles are heavy in themselves, and may transport loads of several hundred kilograms, in some situations tons. When a shuttle rolls over from the rails of a crane to the rails of the pallet rack, the wheels of the shuttle will fall down in the interspace between the rails of the crane and pallet rack respectively and partially hit a leading edge of the rails. In that context, shocks may arise in the storage system together with increased wear and tear on the rails and on the wheels of the shuttle.

### SUMMARY

An object of the present invention is thus to provide a wheel suspension, which removes the above mentioned problems and drawbacks. In accordance with the invention the load on the rails is reduced, particularly where the shuttles move from crane or carriage over to the rails of the pallet rack. A wheel suspension according to the invention is arranged in each corner of a principally rectangular shuttle. Each of those wheel suspensions comprises a bogie, which carries two rotatable shuttle wheels, displaced in the direction of movement of the shuttle. The shuttle wheels rotate in a vertical plane when the shuttle moves back and forth on the rails. The bogie is pivotable around a first axis arranged between the shuttle wheels, and lies in a substantially horizontal plane during rest and standard motion. An underside of the bogie is made as a cam surface, which extends in front of, behind, and below the shuttle wheels.

On each crane and carriage which transports the shuttle, cam rolls are arranged near end points of the rails arranged on the crane and the carriage, respectively. The cam rolls are arranged on a certain height such that the cam surface of a bogie will bear on them. A shuttle leaving the crane or the carriage moves towards the rails of the pallet rack. As the shuttle wheels of the shuttle leaving the rails of the crane or the carriage and passing the interspace between the rails of the crane or carriage and the rails of the pallet rack, a cam surface will engage a cam roll. The entire bogie then will pivot around the first axis and lift the shuttle wheels that are leaving the rails of the crane or carriage.

At the continuing movement of the shuttle a cut-in portion of the cam surface will pass the cam roll, which entails a reversed pivoting of the bogie to the original position in the horizontal plane. Simultaneously, the shuttle wheel that has left the crane or carriage will be lowered down towards the rails of the pallet rack, without touching the end surfaces of the rails.

### BRIEF DESCRIPTION OF THE DRAWINGS

With the purpose to explain the operation and advantages of the invention, various embodiments of the invention are shown on the appended drawings. It should be noted that the embodiments shown on the figures are only exemplary, and that other embodiments are possible within the scope of the invention. In the figures

FIG. 1 a schematic side view of an embodiment of a wheel suspension in accordance with the invention, shown when a first portion of a wheel suspension just has left the rails of a crane,

FIG. 2 a schematic side view of the wheel suspension of FIG. 1, shown when also a second portion of the wheel suspension has left the rails of a crane,

FIG. 3 a schematic view in perspective of an embodiment of a wheel suspension in accordance with the invention,

FIG. 4 schematically a shuttle's transition from crane to pallet rack,

FIG. 5 a schematic side view of an embodiment of a bogie for a wheel suspension in accordance with the invention,

FIG. 6 a schematic side view of an embodiment of a bogie for a wheel suspension in accordance with the invention, when a first portion of the bogie is lifted when engaging a cam roll, and

FIG. 7 a schematic side view of the bogie of FIG. 6, when a second portion of the bogie is lifted when coming to bear against a cam roll,

### THE INVENTION

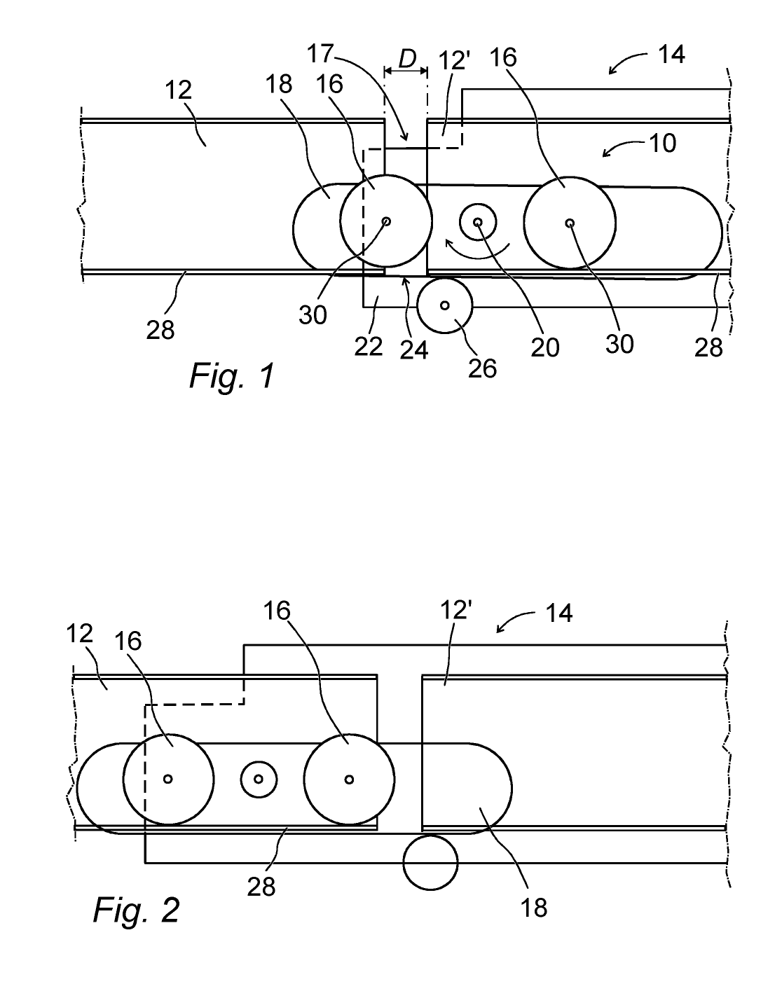

The embodiment of a wheel suspension 10 in accordance with the invention shown in FIG. 1 is arranged on a shuttle 14, which moves on rails 12. The rails 12, shown to the left in FIG. 1 belong to a pallet rack and the rails 12′ shown to the right belongs to a crane (not shown). The wheel suspension 10 is arranged to pivot around a first axis 20 on a side section 22 of a shuttle 14. The wheel suspension carries two shuttle wheels 16 on a bogie 18. The bogie 18 is made with a cam surface 24 on its underside.

The shuttle rests with its shuttle wheels on the rails 16, 16′. In the position shown in FIG. 1, a first shuttle wheel 16 (to the left in the figure) has passed an interspace 17 between the rails of the pallet rack and the rails of the crane. The interspace 17 has a length D, which may be 30 mm or more. In the embodiment shown, both the shuttle wheels 16 of the bogie 18 are arranged at the same height in a vertical plane. The cam surface 24 extends below the shuttle wheels 16.

Near the ends of the rails 12′ the crane carries a stationary arranged cam roll 26. In the position shown in FIG. 1 the cam surface 24 engages the cam roll 26. In to the position shown in FIG. 1 the left portion of the bogie has been lifted upwards when the bogie 18 has pivoted around the first axis 20. This means that a shuttle wheel 16 (to the left in FIG. 1) has been lifted over a horizontal portion 28 of the rail 12 and has not touched the end of the rail 12. The shuttle wheels 16 rotate around horizontally arranged second axes 30.

In the position shown in FIG. 2, also the shuttle wheel 16 in the right of the bogie has passed the interspace 17. Both shuttle wheels 16 now rest on the horizontal portion 28 of the rail 12 of the pallet rack, and the bogie 18 has assumed a completely horizontal position. A rear set of shuttle wheels on a rear bogie (not shown) will in the same way pass the interspace 17, without any shuttle wheel falling down in the interspace 17 between the rails 12, 12′.

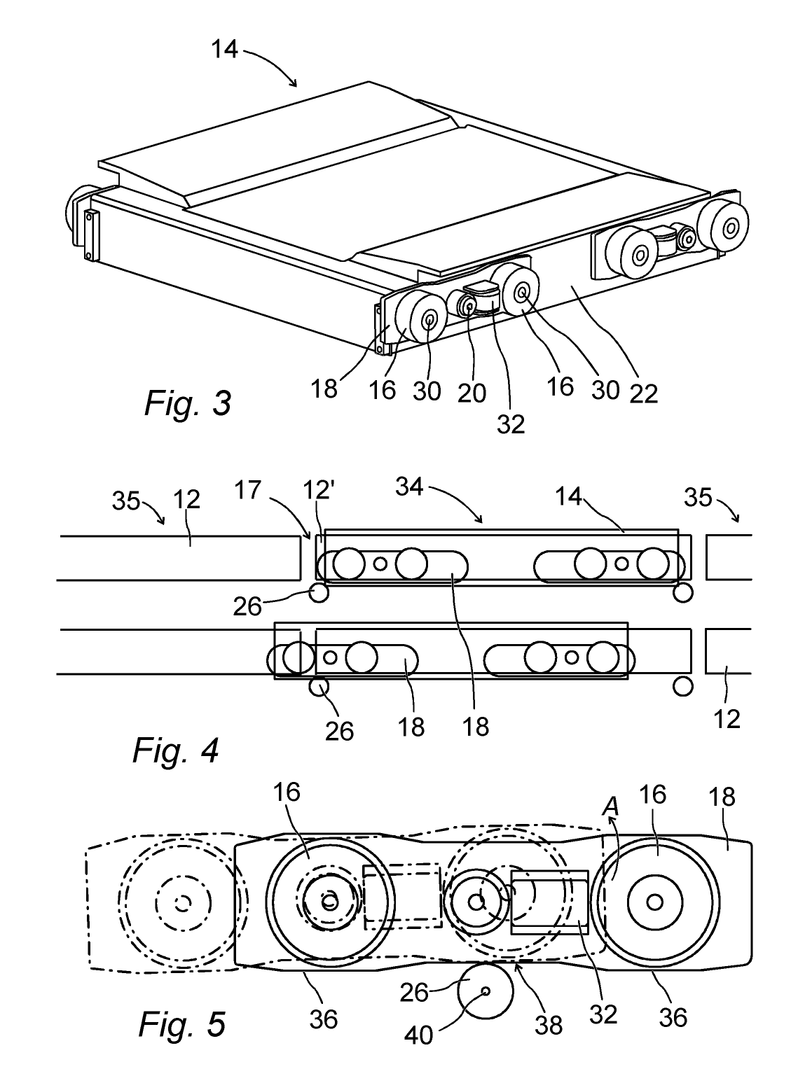

FIG. 3 shows an embodiment of a rectangular made shuttle 14 having a bogie in each corner. The shuttle wheels are made as rubber wheels and are rotatably arranged around the second axes 30 in a side section 22 of each bogie respectively. The entire bogie 18 can pivot around the first axis 20. From FIG. 3 it is also clear that each bogie 18 is provided with a transverse guide wheel 32, which rotates around a vertical axis of rotation. The guide wheels 32 lie against a vertical portion of the rails 12, 12′.

FIG. 4 shows schematically how a shuttle 14 with the aid of the cam roll 26 is “lifted” over the interspace 17 between the rails 12′ of a crane and the rails 12 of a pallet rack 35. This happens when the shuttle 14 moves to the left in FIG. 4 and the bogie 18 with its cam surface is forced upwards when passing the cam roll 26.

With the embodiment of a bogie 18 shown in FIG. 5, the cam surface 24 is made with lowered portions 36 under each shuttle wheel 16 respectively, and with an intermediate elevated portion 38. When the elevated portion 38 passes a cam roll 26, both shuttle wheels rest on rails 12, 12′. When a lowered portion 36 passes the cam roll 26 (dot-dashed position), the corresponding portion of the bogie comes to pivot upwards, as indicated at arrow A, because the lowered portion 36 engages the cam roll 26.

The shuttle wheel which is placed at the lowered portion 36 will in this way be lifted to a position above the rail 12, 12′, whereas the opposite shuttle wheel will still remain and roll against a rail 12, 12′. The cam roll 26 is fixedly attached to the crane, and is suitably rotatably arranged around a third axis 40. The cam roll can be made with rubber coating or similar in order to soften the movement, when the cam curve of the bogie 18 is pressed to engage it. The guide wheel 32 rests against an inner side of the rail 12, 12′ during the transfer of the shuttle.

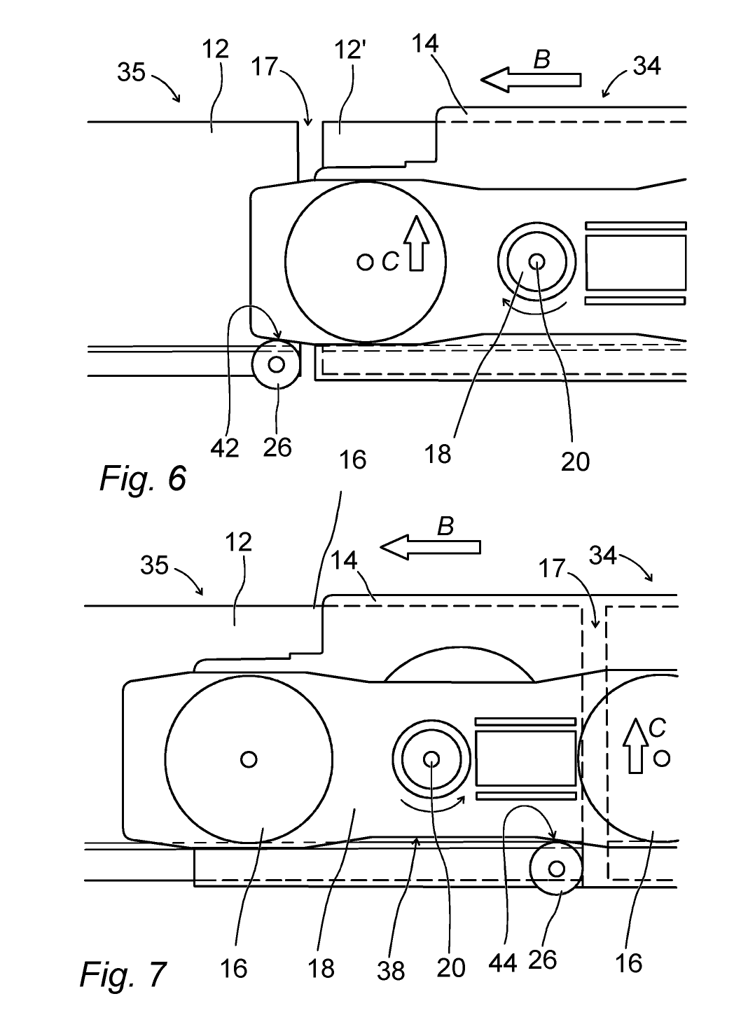

In the embodiment of the bogie 18 shown in FIG. 6 a first oblique portion 42 of the cam surface 24 has come to bear against the cam roll 26 during movement of the shuttle 14 in direction of arrow B. The shuttle wheel lying closest to the oblique portion 42, then will be lifted in the direction of arrow C, and will lie above the rail 12 of a pallet rack 35, when the shuttle wheel 16 has passed the interspace 17. The entire bogie pivots around the first axis 20, at the same time as the entire bogie 18 is slightly lifted upwards.

In FIG. 7 the shuttle 14 with the bogie 18 in FIG. 6 moved further in the direction of the arrow B. The shuttle wheel 16 which was lifted in FIG. 6 now rests against rail 12 of the pallet rack 35. During the passage of the elevated portion 38 past the cam roll 26, both shuttle wheels have rested against rails 12, 12′, respectively. In the position shown in FIG. 7, a second oblique portion 44 has reached the cam roll, which will lift the shuttle wheel 16 lying nearest to the second oblique portion 44.

Also, the entire bogie will pivot around the first axis 20. During the further movement of the shuttle to the left in FIG. 7, the shuttle wheel 16 nearest to the second oblique portion 44 will pass the interspace 17 in a slightly lifted position, and thereafter be lowered down towards the rail 12 of the pallet rack, when the entire cam surface has passed the cam roll 26.

1. A wheel suspension suitable for a basically rectangular shuttle moveable on two parallel elongated rails arranged in a horizontal plane, wherein the wheel suspension comprises:
shuttle wheels arranged in corners of the shuttle,
at least two shuttle wheels separated in the direction of movement of the shuttle and rotatable in a vertical plane, are carried by a bogie, preferably arranged in each corner of the shuttle, wherein
the bogie, is pivotally arranged on a first axis in a side section of the shuttle, wherein the first axis is arranged between the two shuttle wheels carried by the bogie, and in parallel with the axes of the shuttle wheels, and
the bogie on an underside is made with a cam surface, at least partially extending below the shuttle wheels,
wherein the cam surface is arranged to cooperate with a cam roll,
wherein the bogie is arranged to swing up when the cam surface come to bear against the cam roll, the came roll preferably arranged at a rail end, close to a rail interspace, and arranged on and stationary in relation to the rail, in order to prevent the wheel of the bogie to wear the rail close to the rail interspace.

2. The wheel suspension in accordance with claim 1, wherein the cam surface is formed with two lowered portions and between those an intermediate elevated portion.

3. The wheel suspension in accordance with claim 1, wherein the bogie comprises a plane rail sheet of material with second axes carrying the shuttle wheels, and a guide wheel rotating in a horizontal plane.

4. A shuttle, having basically rectangular shape, and being moveable on two parallel elongate rails arranged in a horizontal plane, comprising a wheel suspension according to claim 1.

5. A storage system having a plurality of pairs of elongated rails arranged in parallel in a horizontal plane, and a shuttle movable on a pair of rails and in the rails,
wherein
at least two shuttle wheels separated in the direction of the shuttle and rotatable in a vertical plane are carried by a bogie arranged in each corner of the shuttle, respectively,
the bogie, is pivotally arranged on a first axis in a side section of the shuttle, wherein the first axis is arranged between the two shuttle wheels carried by a bogie, and in parallel with the axes of the shuttle wheels,
the bogie on an underside is formed with a cam surface, at least partially extending below the shuttle wheels, wherein the bogie is pivoted upwardly when the cam surface engages a cam roll arranged stationary in relation to the rail, and
a crane movable between several sets of two elongated rails, and supporting corresponding rails for transporting the shuttle, wherein the cam roll is stationary attached to the crane.
